(19) United States
(12) Patent Application Publication
(10) Pub. No.: US 2011/0281037 A1
(43) Pub. Date: Nov. 17, 2011

(54) ONE-PART DUAL CURING CLEAR COATING COMPOSITION COMPRISING ACRYLIC MODIFIED ACRYLATE FOR CARS AND DUAL CURING PROCESS EMPLOYING THE SAME

(76) Inventors: Jae Woo Lee, Cheonan-si (KR); Seung Man Noh, Yongin-si (KR); Joon Hyun Nam, Cheonan-si (KR); Jong Myung Park, Pohang-si (KR)

(21) Appl. No.: 12/786,302

(22) Filed: May 24, 2010

(30) Foreign Application Priority Data
May 11, 2010 (KR) 10-2010-0044132

(51) Int. Cl. B05D 3/06; C09D 161/28

(52) U.S. Cl. 427/493; 522/105

(57) ABSTRACT

The present invention relates to a one-part dual curing clear coating composition comprising acrylic modified acrylate for cars, the composition containing an acrylic oligomer resin and a melamine resin as main components, and to a dual curing process utilizing the clear coating composition, the process comprising applying the clear coating composition to a substrate to form a coated film and curing the coated film by UV light and heat. According to the present invention, the clear coating composition increases dual coating workability, improves the appearance and mechanical properties of the coated film and is environmentally friendly, because it contains a small amount of a solvent so as to inhibit the emission of volatile organic compounds. In addition, the dual curing process has advantages in that energy consumption and the emission of volatile organic components are reduced compared to existing processes.

### CROSS-REFERENCE TO RELATED APPLICATIONS

This application claims the benefit of Korean Patent Application No. 10-2010-0044132, filed on May 11, 2010 in the Korean Intellectual Property Office, which is incorporated herein by reference in its entirety.

### BACKGROUND OF THE INVENTION

(a) Field of the Invention

The present invention relates to a one-part dual curing clear coating composition comprising acrylic modified acrylate for cars, the composition containing a modified acrylic oligomer resin and a melamine resin as main components, and to a dual curing process employing the clear coating composition, the process comprising applying the clear coating composition to a substrate to form a coated film and curing the coated film by UV light and heat. Thus, the clear coating composition of the present invention can ensure excellent durability and mechanical properties, can shorten a clear coat curing process, and can be environmentally friendly, because it emits a reduced amount of volatile organic compounds.

(b) Background of the Related Art

Unlike general small parts and materials which are coated to protect the surface and to improve their durability, in the case of materials like finished vehicles which have horizontal and vertical parts and must simultaneously satisfy appearance and physical property requirements, a three-dimensional coating process having a technical limitation must be carried out. Particularly in the case of finished vehicles, a considerably difficult curing reaction and process must be understood in order to achieve optimal appearance and physical properties and an optimized printing process only by a simple UV curing process, and the research and development are urgently needed. As is widely known, UV curing paints which are used for the above-described purposes have been used in some products, such as wood materials, mobile phones and some automotive parts, which require fast curing rates. For this purpose, it is required to develop resins which have a molecular weight of about 40,000-50,000 and in which acrylate capable of participating in a UV curing reaction is linked to the terminal ends such that a thermal curing reaction and a UV curing reaction can sequentially or simultaneously occur. The curing rate and density of such resins can vary depending on the content of acrylate linked to the terminal ends. In order to more effectively combine UV curing with thermal curing, it is particularly important to adjust the ratio of the amounts of acrylic resin and acrylate.

Also, conventional UV dual curing systems could react even at low temperature through the use of unblocked free isocynate and could be used only in products which are likely to be thermally deformed, such as plastic or wood materials. Automotive materials are mostly stainless steel plates to which general acrylic melamine systems requiring a high thermal curing temperature higher than 140° C. are suitably applied. Thus, in order to apply a UV dual curing system to such materials, it is also important to select an acrylic resin, which is an oligomer simply having an OH functional group and contains 80-90% OH functional groups as in the case of a general acrylic resin for automobiles so as to be able to impart high weather resistance and workability, a low-temperature curable melamine resin and a suitable reaction catalyst.

A clear coat which is currently most commonly used in paints for cars is a curing system composed of acrylic melamine resin. A process of applying a clear coat for cars is carried out after a process of applying a top/base coat providing the color of automobiles and comprises curing the applied clear coat at 150° C. for 30 minutes to form a clear film. In the curing system of such a structure, hydrolysis by water, and a reduction in the gloss of the film after the occurrence of scratches, and the resulting deterioration in restoration properties are the biggest problems.

UV mono-curing clear coat systems, the development of which was attempted by European advanced companies, are formed by a simple photoinitiation reaction mechanism in which a photoinitiator absorbs UV light to generate free radicals which cause a curing reaction with an oligomer. Such clear coat systems realize a low volatile organic compound content and perfect acid resistance, but a one-part UV curing system could not yet be provided with scratch resistance comparable to that of prior art clear coat systems. For this reason, the mono curing systems have been used in some processes for painting new car parts and in some repair processes. In the bent portion of the car's body, which is the shadow region of cars, and in the inside of the car's body, at which UV light does not directly arrive, the curing density of the mono curing system is rapidly reduced, and the physical properties of the mono curing systems are lower than those of the external portions of general cars, which generally have a baking temperature of 150° C. Thus, it is known that the applicability of application of the mono curing system in cars is low.

Accordingly, recently, in the industrial field of processes for applying clear coats for finished cars, a variety of UV dual curing clear coat systems for finished cars and coating processes have been developed in order to reduce volatile organic compounds (VOCs), improve functionalities such as acid resistance and scratch resistance, reduce energy consumption by significantly shortening automotive painting processes, enhance productivity and increase consumer relevance.

With respect to patent technologies for forming clear coats by dual curing, Korean Patent Registration No. 10-0729804 (published on Jun. 20, 2007) discloses a UV curing transparent paint comprising a first liquid and a second solution, the first liquid comprising 40-60 wt % of an acrylic polyol resin, 2-10 wt of a light-curing oligomer, 2-10 wt % of a light-curing monomer, 3-10 wt % of a photoinitiator, 1-5 wt % of additives, including an urethane catalyst, a surface modifier and a weather resistance improver, and 20-35 wt % of a first organic solvent, the second solution comprising 40-70 wt % of a hexamethylene diisocyanate monomer and 30-60 wt % of a second solvent, wherein the first solution and the second solution are mixed with each other at a volume ratio of 1:0.2 to 0.4, and a method for preparing the UV curing transparent paint. According to the disclosure of the above patent, the two-part paint can be cured and dried by UV irradiation for 1 minute and has the effect of shortening the working time. However, after curing by UV irradiation, the shade region at which light does not arrive must be dried in a drying oven at 60° C. for 30 minutes, and thus the heat-curing time of the shade region is long to reduce energy efficiency, and a reduction in harmful gas emission according to the use of the paint cannot also be expected.

Also, Korean Patent Laid-Open Publication No. 10-2004-0032912 (published Apr. 17, 2004) discloses a coating material curable by heat and irradiation with chemical rays, which comprises: (A) at least one binder selected from the group consisting of addition copolymers of condensation resins and ethylenically unsaturated monomers; and 0.01-3 wt % of at least one additive based on at least one methacrylate copolymer, which has a number-average molecular weight of 4000-100000 Da and is selected from the group consisting of low-polarity to high-polarity methacrylate copolymers. However, the coating material is applied to two-dimensional planar structures other than three-dimensional structures such as wood materials, automotive parts and mobile phones and is cured by heat and irradiation with chemical rays. Thus, the coating material has a problem in that it cannot ensure sufficient physical properties in structures having bent portions, such as cars.

### SUMMARY OF THE INVENTION

Accordingly, the present invention has been made in order to solve the above-described problems occurring in the prior art, and it is an object of the present invention is a one-part dual curing clear coating composition comprising acrylic modified acrylate for cars, wherein the coating composition contains an acrylic oligomer resin and a melamine resin as main components, increases dual curing workability, appearance and mechanical properties and is environmentally friendly, because it contains a small amount of a solvent so as to inhibit the emission of volatile organic compounds.

Another object of the present invention is to provide a dual curing process employing the above one-part dual curing clear coating composition comprising acrylic modified acrylate for cars, wherein the dual curing process comprises coating a substrate with the dual curing clear coating composition having a low solvent content to form a coat film, pre-curing the coat film at low temperature, irradiating the pre-cured coat film with UV light, and then heat-curing the coat film at high temperature, and thus achieves low energy consumption and emits reduced amounts of volatile organic compounds as compared to existing curing processes.

Therefore, the dual curing process according to the present invention can achieve the ideal curing of the internal shadow region of cars and the optimized physical properties of external portions of cars on the basis of the technology which simultaneously utilizes a radical reaction by UV light and a condensation reaction and radical reaction by heat in order to solve the problems of coating processes which are difficult to apply to finished cars. Particularly, unlike existing simple UV curing processes employing monomers, in the dual curing process of the present invention, a modified acrylic resin obtained by attaching a certain amount of acrylate to acrylic resin is used to simultaneously perform heat curing and UV curing, such that physical properties evenly satisfying scratch resistance and acid resistance rather than excessive hardening caused by existing UV curing can be obtained.

To achieve the above objects, in one aspect, the present invention provides a one-part dual curing clear coating composition comprising acrylic modified acrylate for cars, which comprises 60.0-73.5 wt % of a modified acrylic oligomer resin, 2.2-3.5 wt % of a photoinitiator, 1.5-2.5 wt % of a leveling agent, 1.0-1.5 wt % of an UV absorber, 0.3-0.6 wt % of an UV stabilizer, 1.5-2.5 wt % of a catalyst, 15-25 wt % of a low-temperature curing melamine resin and 5-10 wt % of a solvent.

In another aspect, the present invention provides a dual curing process employing a one-part dual curing clear coating composition comprising acrylic modified acrylate for cars, the dual curing process comprising the steps of:

coating a substrate with the one-part dual curing clear coating composition to form a coat film;

pre-curing the coat film at a temperature of 120±1° C. for 1-2 minutes;

irradiating the pre-cured coat film with UV light; and

heat-curing the UV-irradiated coat film at a temperature of 150±1° C. for 10-15 minutes.

As described above, a one-part dual curing clear coating composition comprising acrylic modified acrylate for cars according to the present invention has advantages in that the coating composition increases dual curing workability, appearance and mechanical properties and is environmentally friendly, because it contains a small amount of a solvent so as to inhibit the emission of volatile organic compounds. In addition, according to the dual curing process employing the above one-part dual curing clear coating composition for cars, the dual curing clear coating composition having a low solvent content is coated on a substrate to form a coat film, the coat film is pre-cured at low temperature, the pre-cured coat film is irradiated with UV light, and then the coat film is heat-cured at high temperature, so that low energy consumption is achieved and relatively reduced amounts of volatile organic compounds are emitted as compared to existing curing processes.

### DETAILED DESCRIPTION OF THE PREFERRED EMBODIMENT

The present invention to accomplish the above effects is directed to the one-part dual curing clear coating composition comprising acrylic modified acrylate for cars and the dual curing process employing the clear coating composition. It is to be noted that in the following descriptions, only portions required to understand the present invention will be described and the description of portions other than the above required portions will be omitted to prevent the gist of the present invention from being made unclear.

Hereinafter, a one-part dual curing clear coating composition comprising acrylic modified acrylate for cars according to the present invention will be described in further detail.

The present invention has been made in order to improve the appearance and physical properties (including clarity, gloss, acid resistance, scratch resistance, impact resistance, bending resistance and the like of a coat film compared to those of solvent-type one-part clear coating compositions which have been used in the prior art. In the present invention, raw materials for simultaneously improving dual curing workability, appearance and mechanical properties are used.

A modified acrylic oligomer resin which is used as a main component in the present invention is a resin comprising an oligomer attached to an acrylic resin. It is a modified acrylic oligomer resin which can simultaneously cause a heat curing reaction and a UV curing reaction. Namely, it is an acrylic resin, which has a hydroxyl group and an oligomer group, is obtained by attaching an oligomer having a terminal double bond to a resin having a hydroxyl group and shows different properties depending on the content of the oligomer. It is a resin capable of imparting a good appearance and sufficient mechanical properties (including adhesive strength, acid resistance, scratch resistance, etc.) to a coat film. The acrylic resin is preferably used in an amount of 60.0-73.5 wt %.

If the modified acrylic oligomer resin is used in an amount smaller than the lower limit of the above range, it will not have a curing density necessary for coat film formation, thus making it difficult to realize the various mechanical properties of the film, including adhesive strength, acid resistance and scratch resistance. On the other hand, the modified acrylic oligomer resin is used in an amount larger than the higher limit of the above range, the appearance of the coat film will be deteriorated, the adjustment of workability will be difficult, and the coat film will become excessively hard, thus adversely affecting the chip resistance and adhesive properties of the coat film.

Also, the modified acrylic oligomer resin preferably has an oligomer content of 20-60 wt %, a solid content of 60-65 wt % and a hydroxyl group content of 2.0-2.4 wt %, and shows a glass transition temperature between 20° C. and 30° C. In view of easy workability, the modified acrylic oligomer resin preferably has a viscosity of 500-550 cps, and the color thereof is preferably as transparent as possible, because it is used for external coating.

If the modified acrylic oligomer resin has an oligomer content of less than 20 wt %, it will be difficult to form a UV curing transparent paint having desired physical properties, and if it has an oligomer content of more than 60 wt %, the viscosity of the UV curing transparent paint will be increased, thus making it difficult to achieve a high solid content.

Also, the modified acrylic oligomer resin has a solid content of less than 60 wt %, the appearance and physical properties, including acid resistance, scratch resistance and solvent resistance, can be deteriorated, and if the solid content exceeds 70 wt %, the appearance after coating can be deteriorated, and coating workability can be reduced.

Moreover, the modified acrylic oligomer resin can show different physical properties depending on the oligomer content. In the present invention, because heat curing and UV curing are simultaneously carried out, it is required to adjust the ratio of the acrylic resin to the oligomer resin to a suitable ratio. This ratio is an important factor, because it has a direct influence on the physical properties of the coat film, including scratch resistance and acid resistance.

Moreover, in the present invention, a photoinitiator is used to initiate the double bond of the oligomer. The photoinitiator is a component that absorbs UV light to initiate polymerization and is preferably used in an amount of 2.5-3.5 wt %. If the photoinitiator is used in an amount of less than 2.5 wt %, the drying of the composition will be slow due to the reduction in the reactivity caused by UV light, and if it is used in an amount of more than 3.5 wt %, the appearance of the dried coat film can become poor.

Also, the photoinitiator that is used in the present invention may be one or more selected from the group consisting of benzophenone, benzyl dimethyl ketal, acetophenone, anthraquinone, thioxanthone, acyl phosphine oxide, aminoalkylphenone, hydroxyalkylphenone, dialkoxyacetophenone, benzyl ketone, ketone and the like.

Also, the photoinitiator that is used in the present invention is preferably a mixture of a short-wavelength photoinitiator showing light absorption in a range of 200-350 nm and a long-wavelength photoinitiator showing light absorption in a range of 300-480 nm, which are mixed with each other at a ratio of 8-9:1-2. The use of such different photoinitiators absorbing light in different wavelength ranges makes it possible to uniformly cure the lower portion and upper portion of a thick coat film, thus maximizing the hardness of the coat film.

Particularly, when the short-wavelength photoinitiator and the long-wavelength photoinitiator are used in a mixture, the short-wavelength photoinitiator may be one or more selected from the group consisting of 1-hydroxy-cyclohexyl-phenyl ketone, 2-hydroxy-2-methyl-1-phenyl-1-propanone, 2-hydroxy-1-[4-(2-hydroxyethoxy)phenyl]-2-methyl-1-propanone, methylbenzoylformate, a,a-dimethoxy-a-phenylacetophenone, 2-benzoyl-2-(dimethylamino)-1-[4-(4-morphonyl)phenyl]-1-butanone, 2-methyl-1-4-(methylthio)phenyl]-2-(4-morphonyl)-1-propanone and the like.

Also, the long-wavelength photoinitiator may be one or more selected from the group consisting of diphenyl(2,4,6-trimethylbenzoyl)-phosphine oxide, bis(2,4,6-trimethylbenzoyl)-phenylphosphine oxide and the like.

More specifically, the photoinitiators that are used in the present invention may be initiators absorbing light in different wavelength ranges, such as Irgacure 184/CIBA (1-hydroxy-cyclohexyl-phenyl-ketone), Irgacure 754/CIBA (oxy-phenyl-acetic-acid) and Irgacure 2100/CIBA (phenylbis(2,4,6-trimethylbenzoyl)-phosphine oxide), which are commercially available from Ciba Co., and Lucirin TPO XL/BASF (2,4,6-trimethylbenzoyl-diphenyl-phosphineoxide).

Moreover, the leveling agent that is used in the present invention serves to lower the surface tension of the clear surface layer to impart improved wetting properties to the surface so as to provide stable leveling, thus inducing a beautiful appearance. If the leveling agent is used in an undiluted state, it can excessively reduce the surface tension of the coat film. For this reason, the leveling agent is preferably used after it has been diluted in a solvent to a concentration of 10-20 wt %.

The diluted leveling agent that is used in the present invention is preferably used in an amount of 1.5-2.5 wt %. If the leveling agent is used in an amount of less than 1.5 wt %, it cannot exhibit the leveling effect, and if it is used in an amount of more than 2.5 wt %, it can reduce adhesive property to the surface of a material.

Also, the leveling agent that is used in the present invention is preferably a silicone-based or acrylic leveling agent. Specifically, the silicone-based leveling agent has a polyether-modified dimethylpolysiloxane structure and may be one or more selected from the group consisting of polyether-modified polymethylalkylsiloxane, polyether-modified polydimethylsiloxane and the like.

Specifically, the silicone-based leveling agent that is used in the present invention is preferably a BYK-306 or 325 commercially available from BYK Co. and has a structure of a solution of a polyether-modified dimethylpolysiloxane copolymer.

Also, the acrylic leveling agent that is used in the present invention is preferably one or more selected from the group consisting of BYK-355 and 361. If the acrylic leveling agent or the silicone-based leveling agent has an insufficient effect, the acrylic leveling agent and the silicone-based leveling agent may be used in combination.

The leveling agent that is used in the present invention is preferably BYK-361 commercially available from BYK Co.

Moreover, the UV absorber that is used in the present invention serves to absorb light in a wavelength range of 250-400 μm and to change the UV energy to thermal energy. Also, it must be effective even when it is used in a small amount, and it must absorb light in a wavelength range of 290-400 μm and have excellent thermal stability and compatibility. It is preferably used in an amount of 1.0-1.5 wt %. If the UV absorber is used in an amount of less than 1.0 wt %, the ability to absorb UV light can be reduced, and if it is used in an amount of more than 1.5 wt %, it can provide a turbid appearance.

The UV absorber that is used in the present invention may be one or more selected from the group consisting of benzotriazole, benzylidenehydantoin, benzophenone, benzoguanine and the like.

The UV absorber that is used in the present invention is specifically Tinuvin #400 [hydroxyphenyl-triazine(HPT)] commercially available from Ciba Co., which has strong heat resistance and a solid content of 85% in a 1-methoxy-2-propanol solvent.

Moreover, the UV stabilizer (liquid hindered amine light stabilizer (HALS)) that is used in the present invention serves to remove free radicals produced during a photodecomposition reaction so as to stop a photooxidation reaction. Also, because amine is hindered in the structure of the UV light stabilizer, the UV light stabilizer serves to eliminate free radicals produced by the absorption of the UV absorber. The UV light stabilizer serves to eliminate produced free radicals and, at the same time, has the property of being not consumed. Because the UV absorber and the UV stabilizer can interfere with the activity of the photoinitiator, it is important to determine the wavelength ranges of the UV stabilizer and the UV absorber and the amounts thereof used. The UV stabilizer is preferably used in an amount of 0.3-0.6 wt %. If the UV stabilizer is used in an amount of less than 0.3 wt %, the effect of removing free radicals produced during a photodecomposition reaction so as to stop a photooxidation reaction can be reduced, and if it is used in an amount of more than 0.6 wt %, it can interfere with the activity of the photoinitiator.

The UV stabilizer that is used in the present invention is preferably Tinuvin #292 [bis(1,2,2,6,6-pentamethyl-4-piperidyl)sebacate] which is commercially available from Ciba Co. and serves to prevent cracks loss of gloss of a coat film caused by UV light.

In addition, the catalyst that is used in the present invention serves to promote the curing reaction of the acrylic oligomer resin with the melamine resin and is preferably used in an amount of 1.5-2.5 wt %. If the catalyst is used in an amount of less than 1.5 wt %, the curing reaction does not sufficiently occur, such that the hardness and curing density of the coat film are low, and thus the coat film has weak chemical resistance. On the other hand, if it is used in an amount of more than 2.5 wt %, it can reduce storage stability and increase reaction rate, a compact cured structure cannot be obtained and the coat film can be excessively hard and can be readily cracked.

The catalyst that is used in the present invention is preferably Nacure 4167 (acid phosphate) or Nacure 5925 (dodecyl benzene sulfonic acid, DDBSA) commercially available from KING Co.

In addition, the curing agent (i.e., melamine) which is used in the present invention is preferably a low-temperature curing melamine of Resimene series (INEOS MELAMINE Co.) which can be buthylated or methylated to show high reactivity even at low temperature so that it can react easily and rapidly. It is preferably used in an amount of 15-25 wt %. In order to suitably use a UV-curing reaction by acrylate and a heat-curing reaction by acrylic melamine, it is important to determine a suitable reaction ratio by understanding each reaction mechanism. Generally, methylated melamine has high curing reactivity, is hard and has strong chemical resistance compared to buthylated melamine. On the other hand, buthylated melamine is more flexible and can be advantageous in terms of weather resistance and re-paintability. Because these melamine resins are all of a low-temperature curing type, they require a weak acid catalyst, and storage stability by the catalyst must also be kept in mind.

The curing agent that is used in the present invention is preferably a melamine resin such as Resimene 717 (high-solid methlyated melamin) or Resimene 5901 (high-solid buthylated melamin) commercially available from INEOS MELAMINE Co.

Also, because the present invention is a coating system comprising a slight amount of a co-solvent, the present invention is characterized in that the amount of solvent used is extremely small, unlike general UV curing. Because it is difficult to obtain a sufficient leveling effect merely by maintaining the coat film at room temperature for 10 minutes immediately before curing (the maintenance is to induce the volatilization of a solvent so as to improve pinholes and appearance), a solvent having good compatibility and solubility is preferably used in an amount of 5-10 wt % in order to impart suitable spray workability. Also, it is important to minimize the content of the solvent by sufficiently considering viscosity during the design of main resins. If the solvent is used in an amount of less than 5 wt %, wetting the surface of a base coat with the paint composition will be difficult, the leveling property of the surface can be reduced to make spray coating difficult, and if it is used in an amount of more than 10 wt %, it can reduce the total content of diluted solids, the efficiency of transfer to a substrate during spray can be reduced to increase the consumption of the paint composition, and running of the paint on vertical portions can occur to deteriorate the appearance of the coat film.

The solvent that is used in the present invention may be a ketone-based or acetate-based solvent having good compatibility and solubility and is preferably one or a mixture of two or more selected from the group consisting of PMA (2-methoxy-1-methylethyl acetate 2-methoxypropyl acetate), Slovesso #100(PPG), Butyl Carbitol and EEP (ethyl 3-ethoxypropionate/EASTMAN).

Hereinafter, the dual curing process which employs the above-described one-part dual curing clear coating composition comprising acrylic modified acrylate for cars will be described in detail.

The dual coating system of the present invention is obtained by a method comprising steps of: coating a substrate with the UV dual curing clear coating composition for cars having a low solvent content; pre-curing the painted composition at a temperature of 120±1° C. for 1-2 minutes; irradiating the pre-cured composition with UV light; and heat-curing the UV-irradiated composition at a temperature of 150±1° C. for 10-15 minutes. The dual curing process of the present invention is characterized in that energy consumption is low and the emission of volatile organic compounds is low compared to existing processes. In the pre-curing step, the UV dual curing clear coating composition for cars according to the present invention is coated on a substrate, and then the substrate is mounted on a conveyor and irradiated with UV light at a temperature of 120±1° C. while being passed through a curing oven, whereby the wrinkle and orange feel of the surface can be prevented due to instantaneous curing by UV light irradiation. Then, the pre-cured composition is irradiated with UV light to achieve the stable bond of the oligomer. Then, in the heat-curing step, the composition is irradiated with UV light at a temperature of 150±1° C., whereby a cured system of an acrylic melamine resin can be constructed.

UV light irradiation in the present invention is preferably performed by passing the substrate four times at a conveyor speed of 3.8 m/min at a UV light dose of 1000-1200 mJ/cm² per passage to reach a total light dose of 3000-4000 mJ/cm². If the UV light dose is lower than the lower limit of the above range, the acrylic-melamine reaction cannot sufficiently occur by UV light irradiation, such that the coat film cannot be sufficiently cured, and if the UV light dose is higher than the higher limit of the above range, an acrylate reaction can be predominated to impair the acrylic-melamine reaction caused by heat curing.

Also, the clear coat film which is formed on the substrate by the above process preferably has a thickness of 35-45 μm, and the thickness of the clear coat film is not necessarily limited to the above thickness and can be suitably adjusted depending on design conditions.

Accordingly, the dual curing process according to the present invention can achieve the ideal curing of the internal shadow region of cars and the optimized physical properties of external portions of cars on the basis of the technology which simultaneously utilizes a radical reaction by UV light and a condensation reaction and radical reaction by heat in order to solve the problems of coating processes which are difficult to apply to finished cars. Particularly, unlike existing simple UV curing processes utilizing monomers, in the dual curing process of the present invention, a modified acrylic resin comprising a certain amount of acrylate attached to acrylic resin is used to simultaneously perform heat curing and UV curing, such that physical properties evenly satisfying scratch resistance and acid resistance rather than excessive hardening caused by existing UV curing can be obtained.

Hereinafter, the one-part dual curing clear coating composition comprising acrylic modified acrylate for cars according to the present invention and the dual curing process employing the clear coating composition will be described in detail with reference to examples. It is to be understood, however, that the scope of the present invention is not limited only by the following examples.

1. Preparation of One-Part Dual Curing Clear Coating Composition for Cars

According to the composition ratio shown in Table 1 below, a one-part dual curing clear coating composition comprising acrylic modified acrylate for cars was prepared.

TABLE 1
(unit: wt %)

| Components | Composition Ratio |
|---|---|
| Acrylic resin having hydroxyl group and | 65.0 |
| oligomer group (DCR 4263, Techwin) | |
| Melamine resin (Resimene 717, INEOS | 20.0 |
| MELAMIES Co) | |
| Photoinitiator 1 (Irgacure 754, Ciba Co) | 2.5 |
| Photoinitiator 2 (Lucirin TPO, BASF Co) | 0.5 |
| UV absorber (Tinuvin #400, Ciba Co) | 1.0 |
| UV stabilizer (Tinuvin #292, Ciba Co) | 0.4 |
| Leveling agent 1 10% (BYK-361, BYK) | 1.2 |
| Leveling agent 2 10% (BYK-325, BYK) | 0.6 |
| Catalyst (Nacure 4167, KING) | 2.0 |
| Solvent (KETONE, ACETATE, ETHER) | 6.8 |

As can be seen in Table 1 above, in view of the wavelength range of the UV device, two kinds of photoinitiators capable of absorbing light in a wavelength range of 250-320 nm were used. The silicone-based leveling agent was used to provide smoothness and slippage to the coat film. If the leveling agent is used in an undiluted state, it can excessively reduce the surface tension of the coating film when it is not used in an adjusted amount. For this reason, a dilution obtained by diluting 10 wt % of the leveling agent in a ketone solvent was used.

2. Manufacture of One-Part Dual Curing Clear Coat Film for Cars

### EXAMPLE 1

The one-part dual curing clear coating composition for cars, prepared according to the method of the above section 1, was applied to a substrate, and then pre-cured at a temperature of 120±1° C. for 1 minute. Then, the pre-cured composition was irradiated with UV light by passing it four times at a conveyor speed of 3.8 m/min at a UV irradiation dose of 1000-1200 mJ/cm²per passage to reach a total light dose of 3000-4000 mJ/cm². Then, the composition was heat-cured at a temperature of 150±1° C. for 10 minutes, thus forming a clear coat film having a thickness of 40±5 μm (on a dry film basis).

### COMPARATIVE EXAMPLE 1

The one-part dual curing clear coating composition for cars, prepared according to the method of the above section 1, was applied to a substrate at a temperature of 120±1° C., and the applied composition was pre-cured at a temperature of 120±1° C. for 1 minute. Then, the composition was irradiated with UV light with a total light dose of 3500 mJ/cm². Then, the composition was heat-cured at a temperature of 150±1° C. for 10 minutes, thus forming a clear coat film having a thickness of 40±5 μm (on a dry film basis).

3. Evaluation of One-Part Dual-Cured Clear Coat Films for Cars

The physical properties of the coat films of Example 1 and Comparative Example 1 formed on the substrate according to the method of the above section 2 were evaluated, and the evaluation results are shown in Table 2 below.

TABLE 2

| | | | Comparative |
|---|---|---|---|
| | | Example 1 | Example 1 |
| Test Items | Evaluation Method | (UV curing) | (heat curing) |
| Viscosity | Ford #4/25° C. | 50 seconds | 60 seconds |
| Hardness | Pencil Hardness HB or | HB | HB |
| | more(Mitsubishi) | | |
| Gloss | BYK gloss meter (20 | 99 | 89 |
| | degree) | | |
| Adhesive | 100 × 100 cross-cut | Good | Good |
| property | | | |
| Cold Chip | 50 g, N0. 7 | Fair | Fair |
| resistance | after −20° C. × 3 hr | | |
| Adhesive | Adhesion after | Good | Good |
| property | sedimentation | | |
| in water | 40° C. × 7 days | | |
| Acid | 0.1N sulfuric acid | 37° C. | 34° C. |
| resistance | solution, 36° C. or more | | |
| Scratch | Repeated test of | 63% | 60% |
| resistance | Steelwool 20 times | | |
| Appearance | Wavescan-DOI (CF) | 65 | 62 |

The existing heat-cured acrylic-melamine type coat film of Comparative Example 2 was cured only by heat, whereas the UV-cured coat film of Example 1 was obtained by sequentially applying heat curing and UV curing as described above. Table 2 above shows the results of comparing these coat films. As can be seen in Table 2, hardness and adhesive properties were not greatly different between the two coat films, but the coat film of Example 1 was significantly excellent in scratch resistance, acid resistance and appearance, which are currently the biggest issues of the appearance and physical properties of cars, compared to the coat film of Comparative Example 1.

4. Preparation of One-Part Dual Curing Clear Coating Compositions Having Varying Contents of Acrylate and Melamine

According to the components and contents shown in Table 3 below, one-part dual curing clear coating compositions of Examples 2 to 4 having varying contents of acrylate and melamine were prepared.

TABLE 3

| | Example 2 | Example 3 | Example 4 |
|---|---|---|---|
| Components | (D354) | (D355) | (D356) |
| Acrylate (20 wt % of | 60.0 | — | — |
| oligomer) | | | |
| Acrylate (40 wt % of | — | 65.0 | — |
| oligomer) | | | |
| Acrylate (60 wt % of | — | — | 70.0 |
| oligomer) | | | |
| Melamine | 25.0 | 20.0 | 15.0 |
| Photoinitiator | 3.0 | 3.0 | 3.0 |
| UV absorber and UV | 1.4 | 1.4 | 1.4 |
| stabilizer | | | |
| Leveling agent | 1.8 | 1.8 | 1.8 |
| Catalyst | 2.0 | 2.0 | 2.0 |
| Solvent | 6.8 | 6.8 | 6.8 |

As can be seen in Table 3 above, the content of the oligomer was changed to 20 wt %, 40 wt % and 60 wt % depending on the content of the main resin acrylate, and the prepared compositions were pre-cured and then cured with UV light. The degree of surface curing by pre-curing and UV curing was tested, and on the basis of the test results, the composition ratios of Examples 2 to 4 were determined.

The existing acrylic polymer for cars had a hydroxyl group content of about 80-100%, and thus it could sufficiently react with melamine, even when it did not contain a larger amount of hydroxyl groups, like the case of existing two-part paints.

5. Evaluation of Coat Films Manufactured from One-Part Dual Curing Clear Coating Compositions for Cars Having Varying Contents of Acrylate and Melamine

Coat films manufactured from the one-part dual curing clear coating compositions of Examples 2 to 4 according to the method of the above section 2 were evaluated, and the evaluation results are shown in Table 4 below.

TABLE 4

| | Comparative | | | | Re- |
|---|---|---|---|---|---|
| Test items | Example 1 | Example 2 | Example 3 | Example 4 | marks |
| Initial | 89.3 | 99.1 | 99.4 | 99.3 | BYK |
| gloss | | | | | |
| Gloss after | 54.7 | 59.7 | 63.1 | 63.6 | BYK |
| scratching | | | | | |
| Gloss | 61.3 | 60.3 | 63.5 | 64.1 | Steel- |
| retention (%) | | | | | wool |
| Impact | Good | Good | Good | Good | |
| resistance | | | | | |

Table 4 above shows the results of evaluating the physical properties of the coat films according to the content of acrylate. As can be seen in Table 4, as the content of acrylate was increased, the curing density of the coat films was increased to improve initial gloss, gloss after scratching, and gloss retention.

6. Evaluation of Coat Films According to the Change in Pre-Curing Temperature

In the present invention, a primary heat-curing process in addition to UV irradiation is required, and thus the curing temperature can also be an important factor. Thus, coat films having a thickness of 40±5 μm (on a dry film basis) were formed on substrates using the compositions of Examples 3 and 4 according to the conditions shown in Table 5 below, and the physical properties of the coat films were evaluated. The evaluation results are shown in Table 6 below.

TABLE 5

| | |
|---|---|
| Example 3 | Example 4 |

| Curing condition | a | b | a | b |
|---|---|---|---|---|
| Pre-curing | 100 | 120 | 100 | 120 |
| temperature(° C.) | | | | |
| UV | 3500 | 3500 | 3500 | 3500 |
| irradiation(mJ/cm²) | | | | |
| Heat curing | 150 | 150 | 150 | 150 |
| temperature(° C.) | | | | |

TABLE 6

| | |
|---|---|
| Example 3 | Example 4 |

| Test items | a | b | a | B |
|---|---|---|---|---|
| Hardness | Less than B | HB | Less than B | HB |

As can be seen in Tables 5 and 6 above, in the case a) in which the coat films formed on the substrates using the compositions of Examples 3 and 4 were pre-cured at a temperature of 100° C., the curing density was different from that in the case b) in which the coat films were pre-cured at a temperature of 120° C. In the pre-curing zone, there was no change in curing behavior, but stable and fine pre-curing occurred. When the pre-curing was carried out at a temperature of 120° C. as in Examples 3b and 4b, the completed coat films showed hardness properties.

7. Evaluation of Coat Films According to Change in Process Conditions

In the present invention, process conditions act as important factors. Thus, coat films having a thickness of 40±5 μm (on a dry film basis) were formed on substrates using the compositions of Examples 3 and 4 by a process (a) of performing UV curing after heat curing or a process (b) of performing pre-curing, UV irradiation and then heat curing. The results of evaluating the physical properties of the coat films are shown in Table 7 below.

Generally, automotive clear coats have a thickness of about 35-45 μm which is larger than those obtained by other UV coating processes. Thus, if the automotive clear coats are irradiated with UV light according to a general method, severe damage to the surface of the coat films or deterioration in the physical properties of the coat films can occur due to the cracking or shrinkage of the surface. To overcome this shortcoming, the acrylic modified acrylate resin used in the present invention minimized damage to the surface by delaying instantaneous shrinkage caused by UV irradiation.

TABLE 7

| Test items | Process condition | Example 3 | Example 4 |
|---|---|---|---|
| Hardness | a) UV curing after | B | B |
| | heat curing | | |
| | b) Heat curing after | HB | HB |
| | pre-curing and UV | | |
| | curing | | |
| Appearance | a) UV curing after | Micro pinhole, | Micro pinhole, |
| | heat curing | orange peel | orange peel |
| | b) Heat curing after | Good | Good |
| | pre-curing and UV | | |
| | curing | | |

As can be seen in Table 7 showing hardness and appearance properties, the hardness and appearance properties in the process of performing UV curing after heat curing were inferior to those in the process of sequentially performing pre-curing, UV curing and heat curing.

This suggests that, when the acrylic-melamine reaction occurs earlier than the UV curing reaction, the pure acrylic-melamine bond impairs the flow-ability of acrylate such that the UV curing reaction can no longer be induced, and the reaction is terminated only with a hard acrylic-melamine bond such that the effect of the UV curing reaction cannot be obtained.

On the contrary, when UV curing is carried out after pre-curing, a fine acrylic-melamine reaction occurs to control the instantaneous shrinkage of the coat film surface caused by UV light so as to prevent the formation of wrinkles on the film surface, and the reaction of acrylate by UV light easily occurs. Also, the subsequent heat-curing reaction makes the coat film harder.

In current car production lines, clear coats on the outside of cars are cured at a temperature of about 140-150° C., but in the present invention, the heat curing temperature is lowered to reduce energy consumption and to increase the activity of the oligomer for secondary UV curing. Namely, the heat curing process is shortened to about 15 minutes to reduce energy consumption and to sufficiently provide an environmental factor reducing harmful gas.

As described above, a one-part dual curing clear coating composition comprising acrylic modified acrylate for cars according to the present invention has advantages in that the coating composition increases dual curing workability, appearance and mechanical properties and is environmentally friendly, because it contains a small amount of a solvent so as to inhibit the emission of volatile organic compounds. In addition, according to the dual curing process employing the above one-part dual curing clear coating composition for cars, the dual curing clear coating composition having a low solvent content is coated on a substrate to form a coat film, the coat film is pre-cured at low temperature, the pre-cured coat film is irradiated with UV light, and then the coat film is heat-cured at high temperature, so that low energy consumption is achieved and relatively reduced amounts of volatile organic compounds are emitted as compared to existing curing processes.

While the one-part dual curing clear coating composition comprising acrylic modified acrylate for cars and the dual curing process employing the clear coating composition according to the preferred embodiments of the present invention have been described, it will be readily appreciated by those skilled in the art that it is merely illustrative of the preferred embodiments of the present invention and various modifications and changes can be made thereto within the technical spirit and scope of the present invention.

What is claimed is:

1. A one-part dual curing clear coating composition comprising acrylic modified acrylate for cars, which comprises 60.0-73.5 wt % of a modified acrylic oligomer resin, 2.2-3.5 wt % of a photoinitiator, 1.5-2.5 wt % of a leveling agent, 1.0-1.5 wt % of an UV absorber, 0.3-0.6 wt % of an UV stabilizer, 1.5-2.5 wt % of a catalyst, 15-25 wt % of a low-temperature curing melamine resin and 5-10 wt % of a solvent.

2. The one-part dual curing clear coating composition for cars of claim 1, wherein the modified acrylic oligomer resin comprises an oligomer content of 20-60 wt % and a hydroxyl group content of 2.0-2.4 wt %, and shows a glass transition temperature between 20° C. and 30° C.

3. The one-part dual curing clear coating composition for cars of claim 1, wherein the modified acrylic oligomer resin has a viscosity of 500-550 cps.

4. The one-part dual curing clear coating composition for cars of claim 1, wherein the photoinitiator is a mixture of a short-wavelength photoinitiator showing light absorption in a range of 200-350 nm and a long-wavelength photoinitiator showing light absorption in a range of 300-480 nm, the short-wavelength photoinitiator and the long-wavelength photoinitiator being mixed with each other at a ratio of 8-9:1-2.

5. The one-part dual curing clear coating composition for cars of claim 1, wherein the leveling agent comprises a silicone-based or acrylic leveling agent which is diluted in a solvent to a concentration of 10-20 wt %.

6. The one-part dual curing clear coating composition for cars of claim 1, wherein the melamine is a low-temperature curing melamine which can be buthylated or methylated to show high reactivity even at low temperature so that it can react easily and rapidly.

7. A dual curing process employing a one-part dual curing clear coating composition comprising acrylic modified acrylate for cars, the dual curing process comprising the steps of:
coating a substrate with the one-part dual curing clear coating composition to form a coat film;
pre-curing the coat film at a temperature of 120±1° C. for 1-2 minutes;
irradiating the pre-cured coat film with UV light; and
heat-curing the UV-irradiated coat film at a temperature of 150±1° C. for 10-15 minutes.

8. The dual curing process of claim 7, wherein the UV light irradiation is performed by passing the pre-cured coat film four times at a conveyor speed of 3.8 m/min at a UV light dose of 1000-1200 mJ/cm² per passage to reach a total light dose of 3000-4000 mJ/cm².
